(19) United States
(12) Patent Application Publication
(10) Pub. No.: US 2010/0134812 A1
(43) Pub. Date: Jun. 3, 2010

(54) IMAGE PROCESSING APPARATUS, IMAGE PROCESSING METHOD AND IMAGE FORMING APPARATUS

(75) Inventor: Kunihiko Tanaka, Osaka-shi (JP)

Correspondence Address: HESPOS & PORCO LLP, 110 West 40th Street, Suite 2501, NEW YORK, NY, 10018, US

(73) Assignee: KYOCERA MITA CORPORATION, Osaka-shi (JP)

(21) Appl. No.: 12/624,455

(22) Filed: Nov. 24, 2009

(30) Foreign Application Priority Data
Nov. 28, 2008 (JP) 2008-305072

(51) Int. Cl. G06F 15/00

(52) U.S. Cl. 358/1.9

(57) ABSTRACT

When there is a copy inhibiting dot pattern in an image, an image destruction processing unit performs image destruction processing to image data, and a storage processing unit stores in a storage unit the image data after the image destruction processing. An RGB/CMY conversion processing unit converts the image data into CMY image data C1, M1, Y1, and a UCR/black creation processing unit sets coefficient α of Formula “K1=min (C1, M1, Y1)×α” to “1,” and creates image data K1, C2, M2, Y2 by using Formula “C2=C1−K1, M2=M1−K1, Y2=Y1−K1.”

### BACKGROUND OF THE INVENTION

1. Field of the Invention

The present invention relates to technology for preventing the leakage and forgery of confidential information by way of unauthorized copying of important documents such as confidential documents.

2. Description of the Related Art

Conventionally, image forming apparatuses such as a multi-function peripheral or a copying machine and image reading apparatuses are demanded of functions for inhibiting the unauthorized reading, output and the like of images. In particular, for corporations, since the leakage of confidential information to the outside caused by the unauthorized reading and the like of confidential documents will become a major problem, technology for reliably preventing and restricting the reading and the like of confidential documents is being strongly demanded.

As this type of technology, known is technology of forming a special dot pattern on the background upon outputting confidential documents or the like on a sheet, detecting the dot pattern during the copying process, comparing the detected dot pattern with the copy inhibiting dot pattern stored in the storage area for prohibiting the output, and detecting the coincidence thereof in order to determine whether or not to prohibit the image output of the document image.

Meanwhile, certain multi-function peripherals and copying machines are equipped with a storage unit such as a memory or an HDD having a large storage capacity in consideration of the usability of the image data after the printing, and temporarily accumulates the read document image in such storage unit. With these kinds of machines, even if the special dot pattern is detected from the document and the output thereof is prohibited, if the image data is stored in the storage unit, there is a risk of information leakage caused by the unauthorized removal or carrying out of the storage unit.

In addition, in cases where a prescribed image is included in the scanned document image in order to prevent the foregoing information leakage, technology is also proposed for destroying the image by inserting a destruction pattern in that image.

With image forming apparatuses equipped with such function for destroying the image, there are types which perform image forming operation to the sheet based on the image data after the destruction processing in order to notify the user that the image destruction processing has been implemented.

### SUMMARY OF THE INVENTION

The present invention is a further improvement of the foregoing conventional technology.

Specifically, the present invention provides an image processing apparatus which outputs document image data of a first color system configured from a predetermined plurality of colors to an image forming unit which forms images using developers of a plurality of colors of a predetermined second color system that is different from the first color system, the image processing apparatus comprising: a detection unit which detects whether there is a predetermined image forming inhibiting dot pattern in the document image data of the first color system; an image destruction processing unit which creats destruction data by converting pixel data of respective pixels configuring the document image data into a predetermined same value when the detection unit detects the image forming inhibiting dot pattern; a storage unit which stores the destruction data that has been created by the image destruction processing unit; a conversion processing unit which converts the destruction data stored in the storage unit into image data of the second color system; and a creation processing unit which creats image data including only a component of a specified color as one predetermined color among the respective colors of the developers from the image data converted to the second color system by the conversion processing unit.

### BRIEF DESCRIPTION OF THE DRAWINGS

FIG. 1 is a diagram showing a configuration of an example of a copying machine that is equipped with the image processing apparatus as an embodiment of the present invention;

FIG. 2 is a block configuration diagram showing an example of the electrical configuration of the copying machine;

FIG. 3 is a flowchart showing the processing related to the destruction of the image data;

FIG. 4A is a diagram showing the image of the document before performing the image destruction processing, and FIG. 4B is a diagram showing the image after the image destruction processing was implemented in comparison to the image data of the image shown in FIG. 4A; and

FIG. 5 is a block configuration diagram showing a modified example of the electrical configuration of the copying machine.

### DETAILED DESCRIPTION OF THE PREFERRED EMBODIMENTS

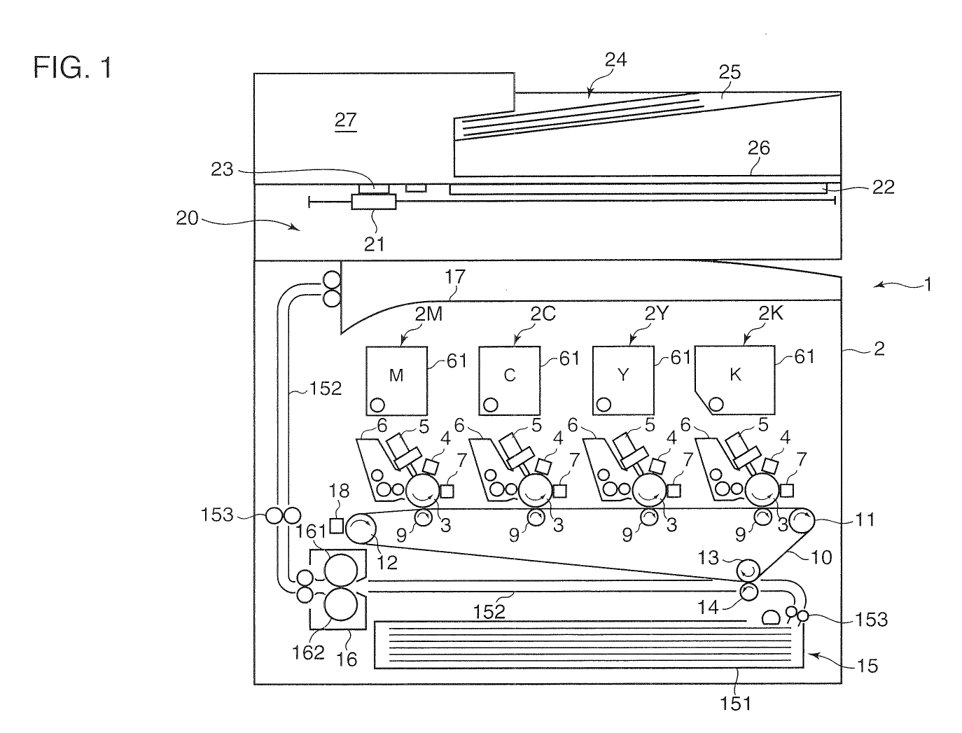

A multi-function peripheral as one embodiment of the image processing apparatus and image forming apparatus of the present invention as well as the image processing method are now explained with reference to the attached drawings. FIG. 1 is a diagram showing the configuration of the multi-function peripheral.

As shown in FIG. 1, the copying machine 1 is provided with, in a row arrangement, image forming units 2M, 2C, 2Y, 2K for each color of magenta (M), cyan (C), yellow (Y) and black (K) in the main body.

The image forming units 2M, 2C, 2Y and 2K (these are hereinafter collectively referred to as the “image forming unit 2”) are used for forming (printing) color images and black-and-white images on a sheet and, comprise a rotatably supported drum-shaped photoreceptor drum 3, for instance, are formed from amorphous silicon, and a charging unit 4, an exposure unit 5, a development unit 6 and a cleaning unit 7 which are arranged around the photoreceptor drum 3.

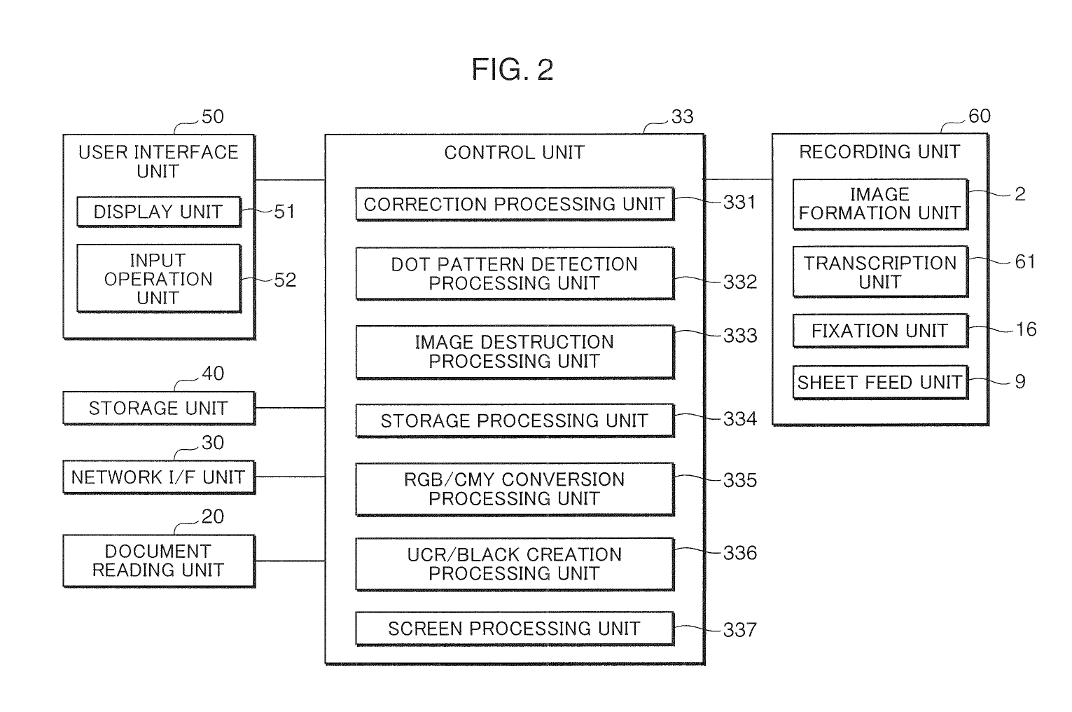

The charging unit 4 uniformly charges the surface of the photoreceptor drum 3 to a prescribed potential. The exposure unit 5 irradiates the laser beam (LED light) created based on the image data sent from storage unit 40 described later (refer to FIG. 2) or the like on the surface of the photoreceptor drum 3, and forms an electrostatic latent image on the surface of the photoreceptor drum 3. The development unit 6 affixes the toner supplied from the toner supply unit 61 onto the electrostatic latent image formed on the photoreceptor drum 3, and thereby produces the electrostatic latent image as the toner image. The cleaning unit 7 removes the toner that remains on the surface of the photoreceptor drum 3 after the primary transfer of the toner image onto the intermediate belt 10 described later.

Provided below the image forming units 2M to 2K are an intermediate transfer roller 9 (primary transfer roller) and an intermediate belt (intermediate transfer belt) 10 for performing intermediate transfer (primary transfer) of the toner image that was formed on the surface of the photoreceptor drum 3. The intermediate belt 10 is formed from a prescribed belt body, and is configured to circle around with the drive roller 11 in a state of being pressed against the photoreceptor drum 3 by the intermediate transfer roller 9 that is arranged opposite the respective photoreceptor drums 3. A driven roller 12 and a tension roller 13 for extending the intermediate belt 10 are rotated by the rotation of the intermediate belt 10. The toner image of the respective colors formed on the photoreceptor drum 3 is transferred and superimposed in the order of magenta, cyan, yellow and black, according to their respective timing, on the intermediate belt 10 that is circling around. A color image formed of the four colors of Y, M, C, K is thereby formed on the intermediate belt 10.

A secondary transfer roller 14 is provided to a position that is opposite the tension roller 13 via the intermediate belt 10. The secondary transfer roller 14 transfers the color image on the intermediate belt 10 onto a sheet by the transfer bias from the control unit 33 described later (refer to FIG. 2).

The multi-function peripheral 1 additionally comprises a sheet feed unit 15 for feeding the sheet toward the image forming units 2Y to 2K. The sheet feed unit 15 includes a sheet feed cassette 151 for housing sheets of different sizes, a transport path 152 as the path on which the sheet is to be transported, and a transport roller pair 153 for transporting the sheet on the transport path 152, and transports one sheet at a time that is taken out from the sheet feed cassette 151 to the image forming units 2Y to 2K; that is, toward the position of the secondary transfer roller 14. The sheet feed unit 15 transports the sheet that was subject to the secondary transfer processing to the fixation unit 16, and discharges the sheet that was subject to the fixation processing 16 to the sheet discharge tray 17 provided at the upper part of the main body of the multi-function peripheral 1.

A fixation unit 16 is provided at a suitable location on the side that is more downstream than the secondary transfer roller 14 of the transport path 152. The fixation unit 16 fixes the toner image that was transferred onto the sheet. The fixation unit 16 is configured from a heat roller 161 and a pressure roller 162, and fixes the toner on the sheet through melting the toner onto the sheet with the heat from the heat roller 161 and pressurization by the pressure roller 162.

The multi-function peripheral 1 additionally comprises a cleaner 18 for removing (collecting) the toner (residual toner) on the intermediate belt 10. The cleaner 18 is configured from a cleaning electrode and a cleaning brush (rotating brush) not shown, and removes the toner by applying the cleaning bias having the polarity that is opposite from the polarity of the charge of the toner onto the cleaning brush based on the cleaning electrode, and removes the toner from the intermediate belt 10 by the electrostatic force thereby.

A document reading unit 20 and a document feed unit 24 are provided at the upper part of the main body of the multi-function peripheral 1. The document reading unit 20 includes a scanning unit 21 configured from a CCD (Charge Coupled Device) sensor having a plurality of pixels and an exposure lamp, a platen 22 configured from a transparent material such as glass, and a document reading slit 23 configured from a transparent material such as glass. The exposure lamp of the scanning unit 21 is configured to be movable by a drive unit not shown, and is moved along the document surface at a position facing the platen 22 when reading the document that is mounted on the platen 22, and, while scanning the document image, outputs the acquired image data (respective pixel data) of R (red), G (green), B (blue) to the control unit 33 (refer to FIG. 2). When reading the document that was fed from the document feed unit 24, the exposure lamp of the scanning unit 21 is moved to a position facing the document reading slit 23, acquires the image of the document in synch with the transport operation of the document by the document feed unit 24 via the document reading slit 23, and outputs the acquired image data to the control unit 33.

The document feed unit 24 includes a document mounting unit 25 for mounting the document, a document discharge unit 26 for discharging the document that has been read, and a document transport mechanism 27 which is configured from a sheet feed roller and a transport roller and so on (not shown) for drawing out the document mounted on the document mounting unit 25 one by one to a position facing the document reading slit 23 and discharging the document to the document discharge unit 26. The document transport mechanism 27 additionally comprises a sheet reversal mechanism (not shown) for flipping the document and re-transporting it to a position facing the document reading slit 23, and is able to read the images on both faces of the document by the scanning unit 21 via the document reading slit 23.

The document feed unit 24 is rotatably provided to the document reading unit 20 so that the front face side thereof is movable in the upper direction. As a result of moving the front face side of the document feed unit 24 in the upper direction and releasing the upper face of the platen 22, a document to be read; for instance, an open book or the like can be mounted by the operator onto the upper face of the platen 22.

FIG. 2 is a block configuration diagram showing an example of the electrical configuration of the multi-function peripheral 1. As shown in FIG. 2, the multi-function peripheral 1 comprises a document reading unit 20, a network I/F (interface) unit 30, a storage unit 40, a user interface unit 50, a recording unit 60, and a control unit 33. Incidentally, the same components as those shown in the configuration of FIG. 1 are given the same reference numeral and the explanation thereof is omitted.

The network I/F unit 30 controls the sending and receiving of various types of data to and from an information processing apparatus (external apparatus) such as a PC that is connected via a network such as a LAN. The storage unit 40 temporarily stores the image data sent from the PC or the like via the network I/F unit 30.

The user interface unit 50 is provided, for instance, on the front part of the multi-function peripheral 1, and includes a display unit 51 for visually providing an operation screen and various messages to the user, and an input operation unit 52 to be used by the user for inputting various commands. The display unit 51 is configured from an LCD (Liquid Crystal Display), an ELD (Electronic Luminescent Display) or the like, and is configured integrally with the touch panel configuring the input operation unit 52. The touch panel detects the touched location when the user performs a touch operation, and outputs the detection signal showing the touched location to the control unit 33 described later. The display unit 51 displays the operation guidance screen to the user showing selections such as paper size, magnification, darkness and so on.

The input operation unit 52 includes a number key pad to be used for inputting the number of sheets to be copied when operating the copy function of the multi-function peripheral 1 and inputting the facsimile number of the destination when operating the facsimile function thereof, a power save button for switching the multi-function peripheral 1 to the power save (low power) mode, a start button for starting the copy operation, scanner operation and so on, a stop/clear button for stopping the copy operation, scanner operation or the like and cancelling the input operation, a reset button for changing the display of the display unit, and the various settings to the initial state or the normal operation state, and various function selection buttons for setting various functions.

The recording unit 60 comprises the foregoing image forming unit 2, the transfer unit 61, the fixation unit 16 and the sheet feed unit 9, and performs image printing on the sheet based on the image data stored in the storage unit 40 or the like. The transfer unit 61 comprises the foregoing intermediate belt 10, the drive rollers 11, a driven roller 12 and a tension roller 13, and the secondary transfer roller 14, and transfers the toner image on the photoreceptor drums 3 onto the sheet via the intermediate belt 10.

The control unit 33 is configured from a ROM (Read Only Memory) for storing various control programs, a RAM (Random Access Memory) having a function of temporarily storing data and a function as a work area, and a CPU (Central Processing Unit) for reading and executing the foregoing control programs from the ROM, and sends and receives various control signals to and from each of the foregoing functional units and governs the operational control of the overall multi-function peripheral 1.

The control unit 33 includes a correction processing unit 331, a dot pattern detection processing unit 332, an image destruction processing unit 333, a storage processing unit 334, an RGB/CMY conversion processing unit 335, a UCR/black creation processing unit 336, and a screen processing unit 337. The respective components 331 to 337 of the control unit 33 may be provided as a circuit, or the CPU may function as the respective components 331 to 337 according to the image processing programs stored in a storage device such as an HDD (Hard Disk Drive) or a memory not shown.

The correction processing unit 331 performs various types of correction processing such as the shading correction of correcting variation in the image data caused by the illumination unevenness of the light source to the document or sensitivity variation of the respective light-receiving sensors in the CCD, the CCD line correction of correcting the displacement caused by the line sensor gap in the respective color components of the CCD, the color aberration correction of correcting color variance caused by the differences in the wave length of respective colors of RGB and the characteristics of an optical system (not shown) of the scanning unit 21, the MTF correction of correcting the “blurring” of the incident light to the CCD caused by the optical system not shown and converting it into a vivid image data, the gamma correction of changing the grayscale characteristics for each color component of each pixel, and the color correction of removing the mixed color component included in the pixel value of each color of RGB for each pixel.

The dot pattern detection processing unit (detection unit) 332 detects, in cases where a copy inhibiting dot pattern is formed on the background portion of the document image, the copy inhibiting dot pattern from the image data that was obtained from the image reading operation of the document reading unit 4. The dot pattern detection processing unit 332 has the copy inhibiting dot pattern pre-stored therein, and, when the dot pattern detection processing unit compares the detected copy inhibiting dot pattern and the pre-stored copy inhibiting dot pattern and the two coincide, outputs an inhibiting signal to the image forming unit 2 for prohibiting the image forming operation of the image forming unit 2.

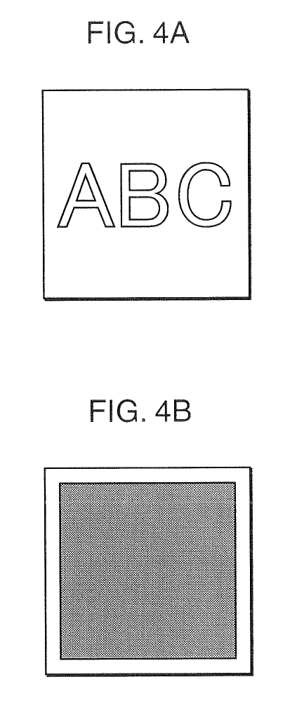

The image destruction processing unit 333 performs destruction processing to the image data that was obtained from the image reading operation of the document reading unit 4 when the copy inhibiting dot pattern is detected by the dot pattern detection processing unit 332. Specifically, in order to perform the image destruction processing of blacking out the reading image shown in FIG. 4A with a black color as shown in FIG. 4B, image destruction processing unit 333 converts the image data of R (red), G (green), B (blue) obtained from the image reading operation of the document reading unit 4 into an image data having the pixel value of R=G=B=0.

The storage processing unit 334 stores the image data after the correction processing performed by the correction processing unit 331 in the storage unit 40 if the copy inhibiting dot pattern is not detected by the dot pattern detection processing unit 332, and stores the image data after the destruction processing (this image data is hereinafter referred to as “destruction data”) performed by the image destruction processing unit 333 in the storage unit 40 if the copy inhibiting dot pattern is detected by the dot pattern detection processing unit 332.

The RGB/CMY conversion processing unit (conversion processing unit) 335 converts the image data having the RGB (first color system) as its color components stored in the storage unit 40 into image data C1, M1, Y1 having CMY (second color system) as its color components by using a well-known conversion formula. When representing the pixel value in 256 grayscale, the image data C1, M1, Y1, after the destruction processing by the image destruction processing unit 333, by being performed the conversion processing with the RGB/CMY conversion processing unit 335 will be C1=M1=Y1=255.

The UCR (Under Color Removal)/black creation processing unit (creation processing unit) 336 performs black creation processing for creating black data K1 based on following Formula (1) from C1, M1, Y1 created with the RGB/CMY conversion processing unit 335, and performs undercolor removal processing using the created black data K1 and the image data C1, M1, Y1. The undercolor removal processing is processing of reducing the gray component configured from the superimposition of the three colors of cyan, magenta, yellow from the image data C1, M1, Y1 and replacing it with a black component, and, for instance, is processing of calculating the image data C2, M2, Y2 subject to the undercolor removal based on the following calculation Formulas (2) to (4) with the black data K1 and image data C1, M1, Y1 as the parameter.

K=min (C1, M1, Y1)×α (α is a coefficient from 0 to 1) (1)

C2=C1−K1 (2)

M2=M1−K1 (3)

Y2=Y1−K1 (4)

Incidentally, the multi-function peripheral 1 includes, as the image adjustment mode, a text mode for executing image processing that is suitable for copying a document image configured from a text image onto a sheet, and a photograph mode of executing image processing that is suitable for copying a document image configured from a photograph image onto a sheet, and the coefficient α is a coefficient that is set to a value that is close to 0 in the case of the photograph mode, and set to a value that is close to 1 in the case of the text mode.

In the present embodiment, if the copy inhibiting dot pattern is detected by the dot pattern detection processing unit 332, the UCR/black creation processing unit 336 sets the coefficient α to “1,” and this point differs from the conventional technology. As a result of setting the coefficient α to “1,” min (C1, M1, Y1)=255. Accordingly, by calculation based on the respective Formulas (1) to (4), black data K1 will be 255 (K1=255), and the image data C2, M2, Y2 will be 0 (C2=M2=Y2=0).

As described above, since the image data of cyan, magenta and yellow will not be generated and only the image data of the black color will be generated, the developer of cyan, magenta, yellow will not be used and only the developer of the black color will be used in performing the image forming operation of showing the user that the image has been destroyed based on the foregoing image data.

The screen processing unit 337 performs screen processing to the image data that was output from the UCR/black creation processing unit 336. The screen processing is processing of representing, in cases where one pixel is divided into a plurality of minute blocks of a matrix shape, the contrasting density of the image of one pixel based on the location or number of blocks to be drawn, and the screen processing unit 337 performs processing using a screen designating the location or number of blocks to be drawn according to the image data.

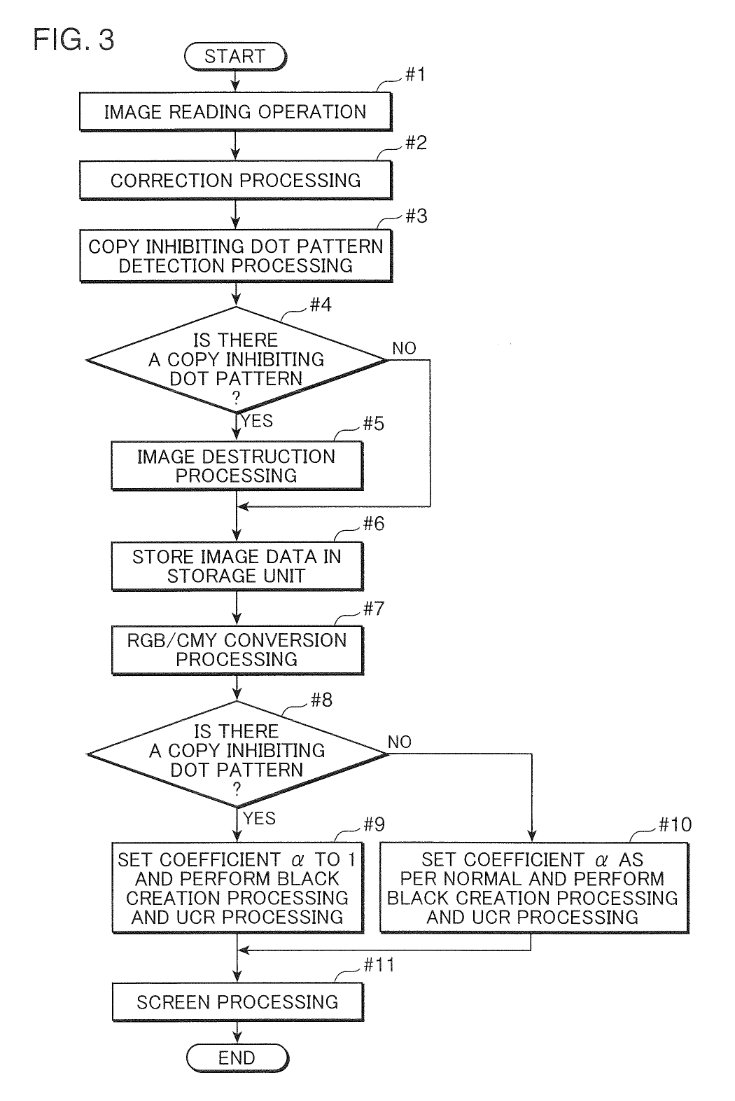

FIG. 3 is a flowchart showing the processing of destroying the image data.

As shown in FIG. 3, the control unit 33 causes the document reading unit 20 to perform the image reading operation to the document (step #1), and the correction processing unit 331 performs the correction processing such as the shading correction to the image data that was obtained from the reading operation (step #2). Subsequently, the dot pattern detection processing unit 332 performs processing to detect whether the copy inhibiting dot pattern exists in the image data after the correction processing of step #2 (step #3), and, if it is determined that the copy inhibiting dot pattern exists (step #4; YES), the image destruction processing unit 333 performs the image destruction processing (R=G=B=0) to that image data (step #5), and on the one hand, if it is determined that the copy inhibiting dot pattern does not exist (step #4; NO), the image destruction processing unit 333 skips the processing of step #5. The storage processing unit 334 thereafter stores the image data after the correction processing by the correction processing unit 331 of step #3 or the image data after the image destruction processing by the image destruction processing unit 333 of step #5 in the storage unit 40 (step #6).

Subsequently, the RGB/CMY conversion processing unit 335 performs processing of converting the image data stored in the storage unit 40 having RGB as its color components into image data C1, M1, Y1 having CMY as its color components (step #7). Here, the image data C1, M1, Y1 to be created when the copy inhibiting dot pattern is detected will be 255 (C1=M1=Y1=255).

If the image includes the copy inhibiting dot pattern (step #8; YES), the UCR/black creation processing unit 336 sets the coefficient α of the calculation Formula (1) to “1,” and then calculates the black data K1 and the image data C2, M2, Y2 based on the calculation Formulas (1) to (4) (K1=255, C1=M1=Y1=0; step #9). Meanwhile, if the image does not include the copy inhibiting dot pattern (step #8; NO), the UCR/black creation processing unit 336 sets the coefficient α as per normal, and creates the black data K1 and the image data C2, M2, Y2 (step #10). The processing of step #10 corresponds to the conventional standard image processing described above.

The screen processing unit 337 performs the screen processing to the image data after the processing of step #9 or #10 (step #11).

As described above, since the processing of converting the destruction data in which the pixel value R, G, B is 0 (R=G=B=0) into an image data including only a component of a black color, the developer of cyan, magenta, yellow will not be used and only the developer of the black color will be used upon performing the image forming operation for showing the user that the image has been destroyed based on the image data after the processing. Consequently, it is possible to avoid the wasteful consumption of the developer in comparison to cases where an image is blacked out with a black color using the developers of cyan, magenta, and yellow.

In addition, simply by setting the coefficient α included in the calculation Formulas (1) to (4) used in the black creation processing and the undercolor removal processing to “1,” the image data of a black color can be made to be an image data having a pixel value other than zero, and the image data of cyan, magenta, yellow can be made to be an image data having a pixel value of zero. Thus, the developer consumption during the image forming for showing the user that the image has been destroyed can be inhibited based on simple processing.

Moreover, since the image data is converted into an image data having only a component of a black color and the image is destroyed (blacked out) with a black developer, it is possible to reliably inform the user that the image destruction processing has been implemented.

Incidentally, a modified embodiment may also be adopted in substitute for or in addition to the foregoing embodiment.

Although the foregoing embodiment performed processing of converting the respective image data of R, G, B into an image data in which the pixel value R, G, B will be 0 (R=G=B=0) as the image destruction processing, the present invention is not limited thereto. Specifically, according to the respective Formulas (1) to (4), if the respective image data of R, G, B are set to the same value, as with the foregoing embodiment, this will result in black data K1=255, and the pixel value of the image data C2, M2, Y2 of the C, M, Y will be C2=M2=Y2=0, and the image can be destroyed by being blacked out only with the black developer.

Moreover, although the foregoing embodiment is based on the assumption of destroying the image by blacking the image out with a black developer, the present invention is not limited thereto, and the image may also be destroyed by being marked out with only a developer of one color among cyan, magenta, yellow. In the foregoing case, the control unit 33 may perform the following processing. The following explanation is based on the precondition that the dot pattern detection processing unit 332 has detected the copy inhibiting dot pattern.

For example, when destroying the image by marking the image out with a cyan developer, foremost, as with the foregoing embodiment, the image destruction processing unit 333 converts the image data of R (red), G (green), B (blue) obtained from the image reading operation of the document reading unit 4 into an image data in which the pixel value is R=G=B=0, and the storage processing unit 334 stores the image data (destruction data) after the destruction processing by the image destruction processing unit 333 in the storage unit 40. Moreover, the RGB/CMY conversion processing unit 335 converts the destruction image data stored in the storage unit 40 into image data C1, M1, Y1 (as with the foregoing embodiment, when representing the pixel value as 256 grayscale, the image data C1, M1, Y1 will be C1=M1=Y1=255) having CMY as its color components based on the foregoing well-known conversion formula.

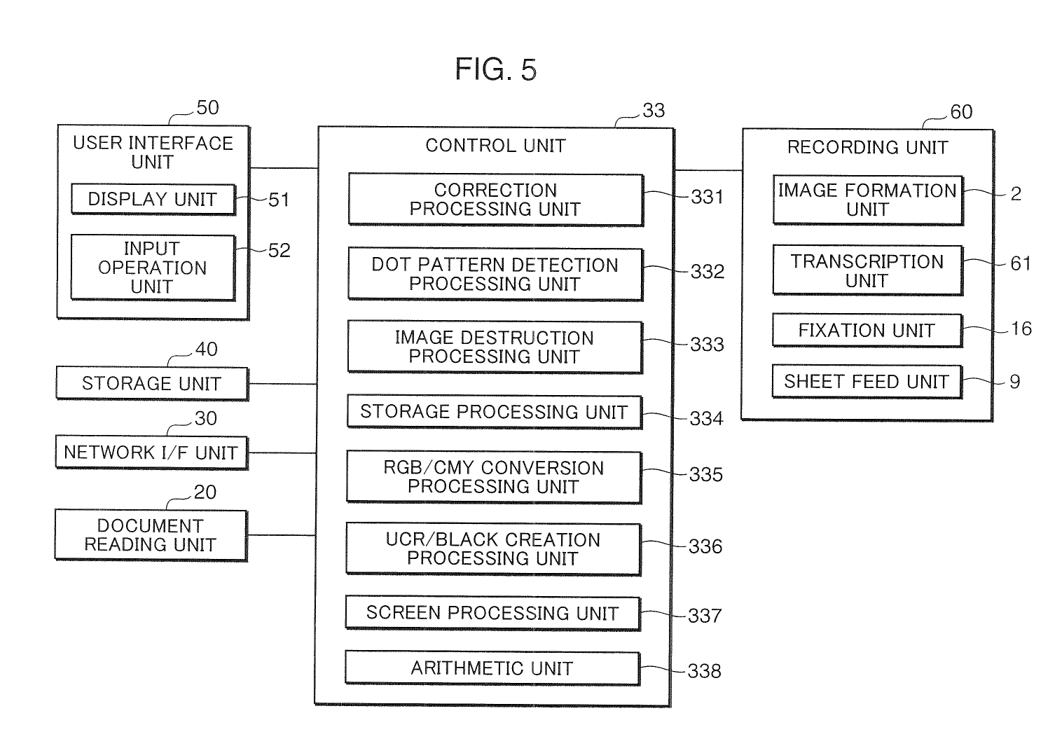

Here, in the present embodiment, as shown in FIG. 5, the control unit 33 is provided with an arithmetic unit 338, and the arithmetic unit 338 performs processing of calculating the image data T1, T2, T3, T4 from the image data C1, M1, Y1 based on the following Formulas (5) to (8):

T1=min (C1, M1, Y1)×α (α is a coefficient from 0 to 1) (5)

T2=C1−T1 (6)

T3=M1−T1 (7)

T4=Y1−T1 (8)

The arithmetic unit 38 sets the coefficient α to “1.” As a result of setting the coefficient α to “1,” min (C1, M1, Y1)=255. Thus, based on the respective Formulas (5) to (8), the calculation will be image data T1=255, and the image data T2, T3, T4 will be T2=T3=T4=0.

The arithmetic unit 338 calculates the image data T1 as the new image data C2 of cyan, and calculates the image data T2, T3, T4 as the new image data M2, Y2, K1 of magenta, yellow and black. Specifically, this will be C2=T1, M2=T2, Y2=T3, K1=T4.

According to the foregoing processing, since the image data of magenta, yellow and black will not be generated and only the image data of cyan will be generated, the developer of magenta, yellow and black will not be used and only the cyan developer will be used when the image forming unit 2 performs the image forming operation to show the user that the image has been destroyed based on these image data.

In addition, when destroying an image by marking the image out with a magenta developer, the processing up to creating the image data T1, T2, T3, T4 is the same as performing the image destruction of marking out the image with a cyan developer, and the arithmetic unit 338 calculates the image data T1 as the new image data M2 of magenta, and calculates the image data T2, T3, T4 as the new image data C2, Y2, K1 of cyan, yellow and black. In other words, this will be M2=T1, C2=T2, Y2=T3, K1=T4.

According to the foregoing processing, since the image data of cyan, yellow and black will not be generated and only the image data of magenta will be generated, the developer of cyan, yellow and black will not be used and only the magenta developer will be used when the image forming unit 2 performs the image forming operation to show the user that the image has been destroyed based on these image data.

Moreover, when destroying an image by marking the image out with a yellow developer, the processing up to creating the image data T1, T2, T3, T4 is the same as performing the image destruction of marking out the image with a cyan or magenta developer, and the arithmetic unit 338 calculates the image data T1 as the new image data Y2 of yellow, and calculates the image data T2, T3, T4 as the new image data C2, M2, K1 of cyan, magenta and black. In other words, this will be Y2=T1, C2=T2, M2=T3, K1=T4.

According to the foregoing processing, since the image data of cyan, magenta and black will not be generated and only the image data of yellow will be generated, the developer of cyan, magenta and black will not be used and only the yellow developer will be used when performing the image forming operation to show the user that the image has been destroyed based on these image data.

According to the present invention of above embodiment, when image forming inhibiting dot pattern data is detected, destruction data obtained by converting the pixel data of the respective pixels configuring the document image data into a predetermined same value is created, and the destruction data is thereafter stored in the storage unit. Thus, even if the storage unit is removed or carried out without authorization, it is possible to prevent the information stored in that storage unit from leaking outside.

Since the destruction data is converted into an image data having a component only of a specified color, when performing the image forming operation based on the destruction data to show that the image has been destroyed, only the developer of the specified color will be used for the image forming operation, and the developer of colors other than the specified color will not be used for the image forming operation. Consequently, it is possible to avoid cases where, even though it would suffice to use a developer of a specified color for the image forming, developers of a plurality of colors are used and the toner consumption is increased when an image data including components of a plurality of colors among the colors of developers from the destruction data.

Moreover, since the destruction data is converted into an image data having a component only of a specified color, the image formed on the recording paper is destroyed (marked out) with a developer of the specified color. Consequently, it is possible to reliably notify the user that the image destruction processing has been performed.

For example, with an image forming apparatus comprising a function of destroying an image for preventing information leakage, when performing destruction processing of blacking out an image data of the respective colors of R (red), G (green), B (blue) with a black color, for example, the image data of the respective colors is converted into an image data in which the pixel value is 0 (zero), and the converted image data is stored in the storage unit. Here, with an image forming apparatus that performs the image forming operation using developers of cyan, magenta, yellow and black, the image data stored in the storage unit needs to be converted into an image data of cyan, magenta, yellow and black. Here, if standard image processing is applied as conventionally, image data having the respective components of the respective colors will be created.

For example, if an R, G, B image data in which the pixel value is zero is converted into an image data of cyan, magenta and yellow, the pixel value shown by such image data will be “255” when represented with 256 grayscale. Consequently, the three developers of cyan, magenta, yellow will be used, and a quantity of developers will be consumed wastefully.

Here, in order to conserve the developers, considered may be a case of performing destruction processing of marking out the image with a white color. Nevertheless, in the foregoing case, if the image forming operation based on the image data after the destruction processing is performed to a white sheet that is generally used, since the output will be in the form of a white sheet, it will be difficult for the user to determine whether the image destruction processing was reliably performed, or whether the image forming operation based on the image data after the destruction processing was not executed due to a malfunction of the image forming apparatus.

Nevertheless, according to the present invention, it is possible to reliably notify the user that the image destruction processing was implemented, inhibit the consumption of developers during the image forming for showing the user that the image has been destroyed, and also reliably prevent the leakage of confidential documents and the like.

This application is based on Japanese Patent application serial No. 2008-305072 filed in Japan Patent Office on Nov. 28, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image processing apparatus which outputs document image data of a first color system configured from a predetermined plurality of colors to an image forming unit which forms images using developers of a plurality of colors of a predetermined second color system that is different from the first color system,
the image processing apparatus comprising:
a detection unit which detects whether there is a predetermined image forming inhibiting dot pattern in the document image data of the first color system;
an image destruction processing unit which creates destruction data by converting pixel data of respective pixels configuring the document image data into a predetermined same value when the detection unit detects the image forming inhibiting dot pattern;
a storage unit which stores the destruction data that has been created by the image destruction processing unit;
a conversion processing unit which converts the destruction data stored in the storage unit into image data of the second color system; and
a creation processing unit which creates image data including only a component of a specified color as one predetermined color among the respective colors of the developers from the image data converted to the second color system by the conversion processing unit.

2. The image processing apparatus according to claim 1, wherein
the first color system is a color system configured from red, green, and blue,
the second color system is a color system configured from cyan, magenta, yellow, and black,
the image destruction processing unit creates, as destruction data, image data by setting all pixel data of red, green, and blue of the respective pixels configuring the document image data to one predetermined pixel value,
the conversion processing unit converts the destruction data into image data C1, M1, Y1 of the respective colors of cyan, magenta, and yellow,
the creation processing unit includes:
a black creation processing unit which sets coefficient α in following Formula (1) to 1, and deriving image data K1 of the black color, based on following Formula (1), from the image data C1, M1, and Y1 converted by the conversion processing unit; and
an undercolor removal processing unit which creates image data C2, M2, and Y2 for cyan, magenta, and yellow subjected to undercolor removal using the image data C1, M1, Y1, and K1 and following Formulas (2) to (4), and sets the image data C2, M2, Y2, and K1 as image data to be output to the image forming unit:
K1=min (C1, M1, Y1)×α (where, α is a coefficient from 0 to 1) (1)
C2=C1−K1 (2)
M2=M1−K1 (3)
Y2=Y1−K1 (4)
min (C1, M1, Y1) being the smallest among image data C1, M1, Y1.

3. The image processing apparatus according to claim 1, whereon
the first color system is a color system configured from red, green, and blue,
the second color system is a color system configured from cyan, magenta, yellow, and black,
the image destruction processing unit creates, as destruction data, image data by setting all pixel data of red, green, and blue of the respective pixels configuring the document image data to one predetermined pixel value,
the conversion processing unit converts the destruction data into image data C1, M1, and Y1 for the respective colors of cyan, magenta, and yellow,
the creation processing unit includes:
a first processing unit which sets coefficient α in following Formula (5) to 1, and deriving image data T1 as image data of the specified color, based on following Formula (5), from the image data C1, M1, and Y1 converted by the conversion processing unit; and
a second processing unit which creats image data T2, T3, and T4 as image data for the respective colors other than the specified color from the image data C1, M1, Y1, and T1 by using following Formulas (6) to (8), and sets the image data T1, T2, T3, and T4 as image data to be output to the image forming unit:
T1=min (C1, M1, Y1)×α (where, α is a coefficient from 0 to 1) (5)
T2=C1−T1 (6)
T3=M1−T1 (7)
T4=Y1−T1 (8)
min (C1, M1, Y1) being the smallest among image data.

4. An image forming apparatus, comprising:
the image processing apparatus according to claim 1; and
an image forming unit which forms images using a developer of each of the colors, wherein
the image forming unit performs image forming operation to a recording medium based on image data that is output from the image processing apparatus.

5. An image processing method for an image processing apparatus for outputting document image data of a first color system configured from a predetermined plurality of colors to an image forming unit which forms images using developers of a plurality of colors of a predetermined second color system that is different from the first color system, the method comprising:
a detection step of detecting whether there is a predetermined image forming inhibiting dot pattern in the document image data;
an image destruction processing step of creating destruction data by converting pixel data of respective pixels configuring the document image data into a predetermined same value when the image forming inhibiting dot pattern is detected in the detection step;
a storage step of storing the destruction data that has been created in the image destruction processing step;
a conversion processing step of converting the destruction data stored in the storage step into image data of the second color system; and
a creation processing step of creating image data including only a component of a specified color as one predetermined color among the respective colors of the developers from the image data converted to the second color system in the conversion processing step.

6. The image processing method according to claim 5, wherein
the first color system is a color system configured from red, green, and blue,
the second color system is a color system configured from cyan, magenta, yellow, and black,
the image destruction processing step is a step of creating, as destruction data, image data by setting all pixel data of red, green, and blue of the respective pixels configuring the document image data to one predetermined pixel value,
the conversion processing step converts the destruction data into image data C1, M1, and Y1 of the respective colors of cyan, magenta, and yellow, and wherein
the creation processing step includes:
a black creation processing step of setting coefficient α in following Formula (1) to 1, and deriving image data K1 of the black color, based on following Formula (1), from the image data C1, M1, and Y1 converted in the conversion processing step; and
an undercolor removal processing step of creating image data C2, M2, and Y2 for cyan, magenta, yellow subjected to undercolor removal using the image data C1, M1, Y1, and K1 and following Formulas (2) to (4), and sets the image data C2, M2, Y2, and K1 as image data to be output to the image forming unit:
K1=min (C1, M1, Y1)×α (where, α is a coefficient from 0 to 1) (1)
C2=C1−K1 (2)
M2=M1−K1 (3)
Y2=Y1−K1 (4)
min (C1, M1, Y1) being the smallest among image data C1, M1, Y1.

7. The image processing method according to claim 5, wherein
the first color system is a color system configured from red, green, and blue,
the second color system is a color system configured from cyan, magenta, yellow, and black,
the image destruction processing step is a step of creating, as destruction data, image data by setting all pixel data of red, green, and blue of respective pixels configuring the document image data to one predetermined pixel value,
the conversion processing step converts the destruction data into image data C1, M1, and Y1 of the respective colors of cyan, magenta, and yellow, and wherein
the creation processing step includes:
a first processing step of setting coefficient α in following Formula (5) to 1, and deriving image data T1 as image data of the specified color, based on following Formula (5), from the image data C1, M1, and Y1 converted in the conversion processing step; and
a second processing step of creating image data T2, T3, and T4 as image data for the respective colors other than the specified color from the image data C1, M1, Y1, and T1 by using following Formulas (6) to (8), and sets the image data T1, T2, T3, and T4 as image data to be output to the image forming unit:
T1=min (C1, M1, Y1)×α (where, α is a coefficient from 0 to 1) (5)
T2=C1−T1 (6)
T3=M1−T1 (7)
T4=Y1−T1 (8)
min (C1, M1, Y1) being the smallest among image data.
